(19) United States
(12) Patent Application Publication
(10) Pub. No.: US 2005/0222310 A1
(43) Pub. Date: Oct. 6, 2005

(54) Use of waxes as lubricants for filled plastics

(75) Inventor: Eric Richter, Thierhaupten (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/099,718

(22) Filed: Apr. 6, 2005

(30) Foreign Application Priority Data
Apr. 6, 2004 (DE) 10 2004 016 791.5

(51) Int. Cl. C08L 91/06

(52) U.S. Cl. 524/275

(57) ABSTRACT

The invention relates to the use of waxes as lubricants for filled plastics.

The present invention is described in the German priority application No.10 2004 016 791.5, filed Jun. 4, 2004, which is hereby incorporated by reference as is fully disclosed herein.

The invention relates to the use of waxes as lubricants for thermosets or thermoplastics comprising fillers and comprising these waxes.

Fillers are generally pulverulent or fibrous substances of organic or inorganic origin which are dispersed in organic media, dispersions, or emulsions with the aim of giving the respective final product certain properties or lowering its production cost. Fillers have to be divided into inorganic and organic materials. Particular importance is attached to calcium carbonate, calcium magnesium carbonate, aluminum silicates, silicon dioxide, magnesium silicates (talc), barium sulfate, aluminum potassium sodium silicates, metals, and metal oxides, aluminum hydroxides, carbon blacks and graphite, wood flour and cork flour, wood particles, wood fibers, glass fibers and natural fibers (H. P. Schlumpf, “Filler and Reinforcements” in R. Gächter, H. Müller, Plastic Additives, 3rd edition, Carl Hanser Verlag Munich 1993, pp. 525-591).

Fillers are widely used. Particular mention may be made here of the following applications related to synthetic materials: paints, coating materials, paper, construction materials, and adhesives. Depending on the application, various properties of the fillers are relevant. Typical parameters are refractive index, binder absorption, specific surface area, opacity, abrasion (process machinery wear), gloss, grain size, and grain size distribution. Particularly in the case of fibrous fillers, compatibility between the filler and the matrix is of particular interest. By way of example, glass fibers are coated with suitable substances in order to improve this coupling between the two materials.

In the course of the last decades, there has been a constant increase in the importance of fillers in plastics processing. In earlier times, fillers were added mainly either to lower the cost of the final product or to increase the quantity of the finished article; subsequently, however, the effect of fillers on processing properties or on finished-product properties has been utilized. Fillers could be used to optimize properties such as processing speed, dimensional stability, flammability, abrasion resistance, electrical tracking resistance, or mechanical properties. In the plastics processing sector fillers are particularly used in polyvinyl chloride, polyethylene, and polypropylene, and also in rubber (natural and synthetic non-crosslinked and crosslinked, e.g. via vulcanization, elastomers). There are only relatively few instances of addition of fillers to engineering thermoplastics (polycarbonate, polymethyl methacrylate, polyamide, polystyrene, etc.).

Wood-filled thermoplastics are established prior art for a very wide variety of applications. Materials incorporated here are wood flour, wood fibers, or wood particles at high concentrations. Filler levels of from 50 to 90% by weight are conventional here. Commercially available thermoplastics are used as matrix material. Mention may be made in particular here of polyvinyl chloride, polypropylene, and the various grades of polyethylene. Less frequently, engineering thermoplastics are also used, examples being polystyrene or other styrene polymers (e.g. ABS). Alongside the main constituents mentioned, the applications also use additives in order to optimize properties. For example, very small amounts of paraffins and amide waxes are added as lubricants to these mixtures. This can give some improvement of profile surface. Polar-modified polypropylene waxes are also used to improve the coupling of the filler to the plastic. Problems hitherto unsolved are rapid ageing of these materials when exposed to weathering, and poor dimensional stability, due to water absorption by wood incorporated into the plastic.

Furthermore, throughputs achievable hitherto through extruders have been only very low. Line speeds are very slow when compared with the state of the art in the remainder of the plastics-processing industry.

Surprisingly, it has been found that addition of waxes to filled plastics delivers performance advantages. The use of appropriate products can give smoother surfaces in the extrusion process, together with higher extrusion speeds. Absorption of water by hydrophilic fillers is moreover retarded and reduced. At the same time, better dimensional stability is achieved.

The invention therefore provides the use of waxes as lubricants for filled plastics.

The waxes preferably comprise synthetic or natural waxes.

The natural waxes preferably comprise petroleum waxes, montan waxes, animal waxes, and/or vegetable waxes.

The synthetic waxes preferably comprise fatty acids, fatty acid esters, fatty acid amides, Fischer-Tropsch waxes, polyolefin waxes, and/or polar-modified polyolefin waxes.

The natural waxes preferably comprise montan waxes.

Montan waxes are ester waxes and/or salts of carboxylic acids. They particularly comprise products of the reaction of the montan wax acids with polyhydric low-molecular-weight alcohols.

These reaction products comprise mixtures of the montan wax acid, the alcohol, the products of partial reaction, and the products of complete reaction of montan wax acid with the alcohol.

The alcohols in particular comprise ethylene glycol, glycerol, butanediol, pentaerythritol, dipentaerythritol, and/or trimethylolpropane.

Examples of preferred natural waxes here are vegetable waxes, such as carnauba wax or candelilla wax, or waxes of animal origin, e.g. shellac wax. Suitable semisynthetic waxes are, by way of example, montan waxes which have been decolorized or, where appropriate, chemically modified, e.g. via esterification and/or via partial saponification. Appropriate materials are described by way of example in Ullmann's Encyclopedia of Industrial Chemistry, 5th Edn., Vol. A 28, Weinheim 1996 in chapters 2.2, 2.3, and 3.1-3.5, pp.110-126.

The materials here preferably comprise entirely synethic non-polar or polar waxes, e.g. polyolefin waxes. Non-polar polyolefin waxes may be prepared via a thermal process to reduce the molecular weight of branched or unbranched polyolefins, or via direct polymerization of olefins. Examples of polymerization processes which may be used are free-radical processes, where the olefins, generally ethylene, are reacted at high pressures and temperatures to give waxes with a relatively high or relatively low degree of branching; and processes where ethylene and/or higher 1-olefins are polymerized with the aid of organometallic catalysts, such as Ziegler-Natta catalysts or metallocene catalysts, to give unbranched or branched waxes. Appropriate methods for preparing olefin homo- and copolymer waxes are described by way of example in Ullmann's Encyclopedia of Industrial Chemistry, 5th Edn., Vol. A 28, Weinheim 1996 in chapter 6.1.1/6.1.2 (high-pressure polymerization), chapter 6.1.3 (Ziegler-Natta polymerization, polymerization using metallocene catalysts), and also chapter 6.1.4 (thermal processes for reducing molecular weight), pp.146-154. Polar polyolefin waxes are produced via appropriate modification of non-polar waxes, e.g. via oxidation using air or via grafting-on of polar olefin monomers, e.g. α,β-unsaturated carboxylic acids and/or their derivatives, such as acrylic acid or maleic anhydride, and/or substituted and/or unsubstituted styrenes and/or vinylsilanes. It is also possible to prepare polar polyolefin waxes via copolymerization of ethylene with polar comonomers, e.g. vinyl acetate or acrylic acid; or via oxidative processes to reduce the molecular weight of relatively high-molecular-weight, non-waxy ethylene homo- and copolymers. By way of example, Ullmann's Encyclopedia of Industrial Chemistry, 5th Edn., Vol. A 28, Weinheim 1996, Chapter 6.1.5, p. 155 gives appropriate examples.

The polyolefin waxes preferably comprise homo- and copolymers of various alkenes.

The polyolefin waxes preferably comprise homo- and copolymers of ethene and of propene.

The polyolefin waxes preferably comprise homo- and copolymers prepared on a Ziegler or metallocene catalyst.

The polyolefin waxes preferably comprise polar-modified polyolefin waxes. The polar-modified polyolefin waxes preferably comprise oxidation products or graft copolymers.

The polar-modified polyolefin waxes particularly preferably comprise oxidation products.

The oxidized polyolefin waxes preferably comprise products with a drop point of from 90 to 170° C.

The oxidized polyolefin waxes particularly preferably comprise products with a drop point of from 95 to 130° C.

The oxidized polyolefin waxes preferably comprise products with a melt viscosity of from 1 to 10 000 mPas at 140° C.

The oxidized polyolefin waxes particularly preferably comprise products with a melt viscosity of from 10 to 1000 mPas at 140° C.

The oxidized polyolefin waxes preferably comprise products with an acid number of from 1 to 50 mg KOH/g.

The oxidized polyolefin waxes particularly preferably comprise products with an acid number of from 5 to 30 mg KOH/g.

The amount preferably used of the waxes is from 0.05 to 10% by weight, based on the entire formulation.

The amount particularly preferably used of the waxes is from 1.0 to 6.0% by weight, based on the entire formulation.

The fillers are particularly preferably inorganic and/or organic fillers.

The inorganic fillers preferably comprise calcium carbonate, calcium magnesium carbonate, aluminum silicates, silicon dioxide, magnesium silicates (talc), barium sulfate, aluminum potassium sodium silicates, metals and metal oxides, and/or aluminum hydroxides.

The organic fillers preferably comprise carbon blacks and graphite, wood flour and cork flour, wood particles, wood fibers, glass fibers and natural fibers, and/or organic pigments.

The amount preferably used of the fillers is from 1 to 99% by weight, based on the entire mixture.

The amount particularly preferably used of the fillers is from 50 to 90% by weight, based on the entire mixture.

The invention also provides a thermoplastic or thermoset, comprising from 1 to 99% by weight of a filler coated with the wax described.

The material preferably comprises a thermoplastic or thermoset comprising from 50 to 95% by weight of a wax-coated filler.

The thermoplastic, vulcanizable plastic (rubber), or thermoset preferably comprises polyvinyl chloride, HD (high-density) polyethylene, LD (low-density) polyethylene, LLD (linear low-density) polyethylene, polypropylene, natural rubber, synthetic rubber, polycarbonate, polymethyl methacrylate, polyamide, styrene polymers, and/or blends composed of various plastics.

There are various ways of introducing the wax into the mixture: for example, the wax may be applied in an existing or new step of a process in the form of an aqueous dispersion. It is also possible to apply a wax melt to the filler by spraying. It is also possible to homogenize a mixture composed of filler and wax in a mixing assembly (e.g. blade mixer). It is also possible to meter the wax directly, without any other premixing, directly into the processing machine by volumetric or gravimetric means and thus delay contact between the individual components until that point has been reached.

### EXAMPLES

Commercially available wood particles were premixed with various waxes and with a commercially available polypropylene, and then this mixture was compounded in an extruder. The pelletized compounded materials were processed by means of injection molding to give moldings. These parts were subjected to various studies. A product readily available in the market was introduced into the tests as a comparison. These mixing specifications are indicated by B and represent the prior art.

Compounded material A comprises 70% by weight of wood particles and 37% by weight of PP, and 3% of adhesion promoter.

Compounded material B comprises 4% by weight of a commercially available additive for the wood/polypropylene system and 70% by weight of wood particles, 3% of adhesion promoter, and 23% by weight of PP.

Compounded material C comprises 4% by weight of oxidized poly-ethylene wax as additive for the wood/polypropylene system and 70% by weight of wood particles, 3% of adhesion promoter, and 23% by weight of PP.

Compounded material D comprises 4% by weight of montan wax ester as additive for the wood/polypropylene system and 70% by weight of wood particles, 3% of adhesion promoter, and 23% by weight of PP.

Characterization of particularly suitable waxes:

Oxidized polyethylene wax

| | |
|---|---|
| Drop point: | about 104° C. |
| Acid number: | about 17 mg KOH/g |
| Viscosity: | about 300 mPas at 120° C. |

Montan wax ester

| | |
|---|---|
| Drop point: | about 76° C. |
| Acid number: | max. 40 mg KOH/g |
| Saponification number: | about 148 g KOH/g |

Preparation of compounded material: All of the pulverulent constituents were homogeneously mixed in a tumbling mixer. This mixture was processed to give pellets, using a corotating twin-screw extruder. Water absorption was studied to DIN EN ISO 62.

| | A | B | C | D |
|---|---|---|---|---|
| Die pressure [bar] | 118 | 99 | 69 | 56 |
| Melt temperature 1 [° C.] | 177 | 195 | 199 | 198 |
| Melt temperature 2 [° C.] | 194 | 210 | 215 | 215 |
| Melt temperature (die) [° C.] | 191 | 191 | 190 | 186 |
| Load [%] | 16 | 13 | 10 | 10 |
| Total power [W] | 6040 | 5500 | 4720 | 4630 |
| Rotation rate [min⁻¹] | 30 | 30 | 30 | 30 |
| Output [kg/h] | 6.8 | 6.9 | 7.2 | 7.2 |
| Appearance of extruded strip | poor | poor | good | good |
| Water absorption after 20 days [%] | 114 | 112 | 110 | 109 |

Maximum output with good surface:

| | A | B | C | D |
|---|---|---|---|---|
| Maximum output with good surface | 5 | 6 | 8 | 8.5 |
| [kg/h] | | | | |

The test values listed clearly show that compounded material C and D have by far the best processing properties and the smallest water absorption.

1. The process for lubricating a plastic during formation, wherein the plastic has at least one filler, comprising the step of adding a lubricant to the mixture of plastic and at least one filler, wherein the lubricant is at least one wax.

2. The process as claimed in claim 1, wherein the at least one wax is a synthetic or natural wax.

3. The process as claimed in claim 1, wherein the at least one wax is selected from the group consisting of petroleum waxes, montan waxes, animal waxes, and vegetable waxes.

4. The process as claimed in claim 1, wherein the at least one wax is selected from the group consisting of fatty acids, fatty acid esters, fatty acid amides, Fischer-Tropsch waxes, polyolefin waxes, and polar-modified polyolefin waxes.

5. The process as claimed in claim 1, wherein the natural at least one wax is a montan wax.

6. The process as claimed in one claim 5, wherein the montan wax is the products of the reaction of montan wax acid with at least one low-molecular-weight alcohol.

7. The process as claimed in claim 6, wherein the at least one low-molecular-weight alcohol is selected from the group consisting of ethylene glycol, glycerol, butanediol, pentaerythritol, dipentaerythritol, trimethylolpropane and mixtures thereof.

8. The process as claimed in claim 1, wherein the at least one wax is a polyolefin wax.

9. The process as claimed in claim 1, wherein the at least one wax is a polar-modified polyolefin wax.

10. The process as claimed in claim 1, wherein the at least one wax is an oxidized polyolefin wax.

11. The process as claimed in claim 1, wherein the at least one filler is an inorganic or organic filler.

12. The process as claimed in claim 1, wherein the at least one filler is selected from the group consisting of calcium carbonate, calcium magnesium carbonate, aluminum silicates, silicon dioxide, magnesium silicates, barium sulfate, aluminum potassium sodium silicates, metals and metal oxides, and aluminum hydroxides.

13. The process as claimed in claim 1, wherein the at least one filler is selected from the group consisting of carbon blacks, graphite, wood flour, cork flour, wood particles, wood fibers, glass fibers, natural fibers, and organic pigments.

14. The process as claimed in claim 1, wherein the amount used of the at least one wax is from 0.05 to 10% by weight.

15. The process as claimed in claim 1, wherein the amount used of the at least one wax is from 1.0 to 6.0% by weight.

16. The process as claimed in one or more of claims 1 to 15, wherein the plastic comprises from 1 to 99% by weight of the at least one filler.

17. The process as claimed in claim 1, wherein the plastic comprises from 50 to 90% by weight of at least one filler.

18. The process according to claim 1, wherein the plastic is selected from the group consisting of polyvinyl chloride, polyethylene, polypropylene, natural rubber, synthetic rubber, polycarbonate, polymethyl methacrylate, polyamide, styrene polymers, and mixtures thereof.

19. A plastic made in accordance with the process of claim 1.

20. The process according to claim 1, wherein the plastic is a thermoplastic, thermoset or vulcanizable plastic.

21. The process of claim 1, wherein adding step further comprises adding the at least one wax in an aqueous dispersion.

22. A process for lubricating a plastic during formation of the plastic, wherein the plastic has at least one filler, comprising the step of coating the at least one filler with a lubricant to form coated particles and adding the coated particles to the plastic, wherein the lubricant is at least one wax.

23. The process as claimed in claim 22, wherein the coating step further comprises spraying the at least one wax onto the at least one filler.

24. A process for lubricating a plastic during formation of the plastic, comprising the step of mixing at least one filler and a lubricant to form a mixture and adding the mixture to the plastic.

25. A plastic made in accordance with the process of claim 22.

26. A plastic made in accordance with the process of claim 24.
